(19) United States
(12) Patent Application Publication
(10) Pub. No.: US 2001/0009927 A1
(43) Pub. Date: Jul. 26, 2001

(54) METHOD OF SOIL REMEDIATION

(76) Inventors: UPALI WEERASOORIYA, AUSTIN, TX (US); LARRY N. BRITTON, SPICEWOOD, TX (US); ALLEN M. NIELSEN, AUSTIN, TX (US); STEVE V. ORSAK, LAKE CHARLES, LA (US); FRANK GATES, MCNEIL, TX (US)

Correspondence Address: C JAMES BUSHMAN, BROWNING BUSHMAN, 5718 WESTHEIMER SUITE 1800, HOUSTON, TX, 77057

(21) Appl. No.: 09/225,964

(22) Filed: Jan. 6, 1999

(51) Int. Cl. B01F 17/00

(52) U.S. Cl. 516/90

(57) ABSTRACT

A surfactant composition useful in soil remediation comprising compounds having the structure:

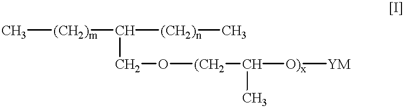

wherein m+n is from 8 to 11, x is from 2 to 10, Y is a hydrophilic group, and M is a cation.

### BACKGROUND OF THE INVENTION

1. Field of the Invention

The present invention relates to surfactants compositions and, more particularly, to the surfactant compositions obtained from propoxylated monobranched alcohols.

2. Description of the Prior Art

Soil remediation has become an increasingly important aspect of preserving the environment. It is well known that there are numerous land sites that, via neglect or by accident, are heavily contaminated with generally water-insoluble, organic materials— e.g., diesel and other fuel oils, chlorinated organics, etc. These soil contaminants present particularly acute problems to clean up inasmuch as typically the contaminants will permeate deeply into the soil and, if not removed, can percolate down to the water table contaminating aquifers and the like. Numerous and mostly expensive techniques have been proposed to effect soil remediation; i.e., remove organic contaminants that have been spilled on land areas. Foremost among these techniques is thermal remediation, in which the contaminated soil is heated to a sufficiently high temperature to effectively drive off the organic pollutants from the contaminated soil. Leaching techniques have also been employed to remove the pollutants from the soil. As noted, these techniques are expensive, time-consuming and for the most part limited in that they are most suitable for land spills in which the pollutant has not penetrated too deeply below the surface. Clearly, a process that would permit recovery of organic contaminants that have permeated more deeply into the soil is greatly desired.

It is well known in the petroleum industry to use what are known as “tertiary,” or “enhanced,” recovery techniques to recover petroleum from a reservoir or formation that has stopped producing because of decreased formation pressure. One of the most widely used enhanced recovery techniques in the petroleum industry is what is known as “waterflooding,” in which water or some other aqueous fluid is introduced through injection wells to force oil through the formation to offset producing wells. Typically, in waterflood operations, surface-active agents or surfactants are employed as part of the aqueous fluid to lower interfacial tension between the water and the formation oil, permitting oil droplets to deform, coalesce, and flow with the flood water toward the offset producing wells.

U.S. Pat. No. 4,293,428, incorporated herein by reference for all purposes, discloses a waterflooding technique that employs a particular surfactant that exhibits a high degree of surface activity in reservoirs having a high concentration of inorganic salts. In the waterflood process disclosed in U.S. Pat. No. 4,293,428, the surfactants are derived from propoxylated/ethoxylated alcohols, which require a certain ordering of the alkoxyl groups in order to be useful in the waterflood process, particularly in the presence of brines commonly found in oilfield environments.

It has now been proposed to use what basically amounts to waterflood techniques in soil remediation. The thrust of this approach is to find surface-active agents that exhibit good oil solubility so as to be effective on the organic pollutants but that also exhibit controllable biodegradability so as to have a longer effective life. Lastly, the surface-active agents need to have low toxicity.

### SUMMARY OF THE INVENTION

It is therefore an object of the present invention to provide a new surfactant composition.

Another object of the present invention is to provide a surfactant or surface-active composition that can be used in soil remediation.

Still a further object of the present invention is to provide a surfactant or surface-active composition that can be used in soil remediation techniques based on waterflooding commonly practiced in the oil and gas industry as an enhanced recovery technique.

The above and other objects of the present invention will become apparent from the description given below and the appended claims.

The surfactant composition of the present invention comprises compounds having the structure:

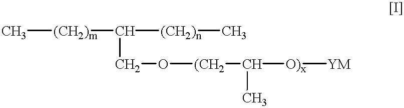

wherein m+n is from 8 to 11, x is from 4 to 8, Y is a hydrophilic group, and M is a cation, preferably monovalent.

### DESCRIPTION OF THE PREFERRED EMBODIMENTS

The surfactants of the present invention comprise compounds having the structure:

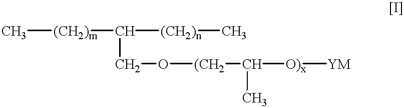

wherein m+n is from 8 to 11, x is from 4 to 8, Y is a hydrophilic group and M is a cation.

The alcohols that are used as starting materials in producing the surfactants of the present invention can be generally characterized as monobranched alcohols having an alkyl chain length (total carbons) of 12 to 15 carbon atoms. Such alcohols are conveniently obtained as a fraction of alcohols produced by hydroformalation of internal olefins. Commercially, such monobranched alcohols are sold under the trademark ISALCHEM by Condea-Augusta S.p.A. Useful monobranched alcohols that can be used as starting materials include those having the formula:

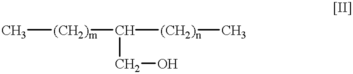

wherein m+n=8 to 9 with the proviso that if m is 0, n is 8 to 9; alcohols having the formula:

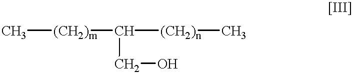

wherein m+n=8 to 11 with the proviso that if m is 0, n is 8 to 11; and alcohols having the formula:

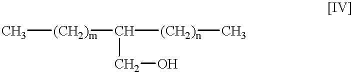

wherein m+n=10 to 11 with the proviso that if m is 0, n is 10 to 11.

Thus, it can be seen that in general the monobranched alcohols useful as starting materials in preparing the surfactants of the present composition will contain from 12 to 15 carbon atoms, alcohols having a total of 12 to 13 carbon atoms and satisfying Formula II, alcohols having from 12 to 15 carbon atoms and satisfying Formula III, and alcohols having from 14 to 15 carbon atoms and satisfying Formula IV being particularly preferred.

It will be appreciated that the starting monobranched alcohols used to prepare the surfactants of the present invention are mixtures and may contain lesser amounts of linear alcohols. It will also be appreciated that while specific, preferred monobranched alcohols are shown above, it will be appreciated that various isomers of such alcohols can be employed provided that the total number of carbon atoms in the monobranched alcohols remains between 12 and 15.

In preparing the surfactants of the present invention, the monobranched alcohols are first reacted with propylene oxide to yield an alcohol propoxylate. The average number of propoxy units—i.e., the value of x—will generally vary from 2 to 10, preferably from 4to 8.

Methods of propoxylation are well known to those skilled in the art. For example, the reaction can be achieved using a strong base or Lewis acid catalyst such as NaOH, KOH, BF₃, or SnCl₄. Examples of other suitable bases include sodium phenolate and alkali metal alkoxides such as sodium methoxide or propoxide. Other suitable acids include BF₃-etherate, p-toluene sulfonic acid, fluorosulfonic acid, aluminum butyrate, and perchloric acid.

Following the propoxylation reaction, the resulting alcohol propoxylate is combined with a suitable hydrophilic group (Y). Suitable hydrophilic groups include sulfate, sulfonate, phosphate, carboxylate, and mixtures ofthe above. In general, sulfate or sulfonic groups are preferred.

Methods of combining the alkyl propoxylated ether with the hydrophilic group are well known to those skilled in the art. For example, in the case where it is desired that the hydrophilic group be a sulfate, the alcohol propoxylate can be reacted, in the well known manner, with SO₃/air in a standard batch or falling film sulfator, the sulfated material being neutralized with aqueous NaOH and the pH adjusted to the desired range.

When it is desired that the hydrophilic group be a sulfonate, this can be accomplished, for example, by reacting the alcohol propoxylate and a suitable alkali metal to form what may be referred to as a the metal etherate, which in turn can be reacted with a large number of compounds to yield surfactants wherein the hydrophilic group Y has the following structure:

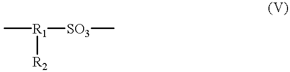

wherein R₁ is an alkyl, cycloalkyl, alkenyl, alkaryl, or aryl radical containing up to 8 carbon atoms and R₂ is hydrogen, a hydroxy radical, or an aliphatic radical containing from 1 to 8 carbon atoms.

For example, the metal etherate may be reacted with chloromethyl sulfonate, vinyl sulfonate, 1,3-propane sultone, or 1,4-butane sultone to prepare compounds wherein R₂ is hydrogen. The metal etherate may also be reacted with 3-methylpropane sultone or 4-methylbutane sultone to prepare compounds wherein R₂ is a methyl group. The metal etherate may also be reacted with hydroxyvinyl sulfonate, 3-hydroxypropane sultone, or 4-hydroxybutane sultone to prepare compounds wherein R₂ is a hydroxyl group. The sultones used for the sulfonation of the metal etherates are cyclic esters of hydroxysulfonic acids. The name “sultone” is derived from its formal resemblance to lactone. Considerable literature has been devoted to sultones, and the chemistry of the propane and butane sultones is well known to the art. See, for example, R. F. Fisher, Industrial and Engineering Chemistry, Vol. 56, No. 3, March 1964, pp. 41-45.

Alternatively, the alcohol propoxylate may be reacted with phosphorus pentoxide to form a phosphate. If desired, a catalyst such as BF₃-etherate complex may be used. The resulting product is then neutralized with an alkali metal base, such as sodium or potassium hydroxide, or sodium or potassium carbonate, or the like, to form an alkali metal salt.

Still alternatively, a carboxylate group may be incorporated into the alcohol propoxylate by any number of well-known methods. For example, the alcohol propoxylate may be reacted with a halogen carboxylic acid to result in an alcohol propoxy carboxylic acid. The resulting product is then neutralized using an alkali metal base to form a carboxylate surfactant having the general structure shown in Formula I.

As noted, the techniques of proxylation, sulfation, sulfonation, phosphination, and carboxylation, which that can be used to prepare the various surfactant embodiments of this invention, are generally well known in the art. See, for example, U.S. Pat. No. 3,931,271 and J. Chlebicki, et al., “Synthesis and Surface Activity of Sodium Polyoxypropylated Higher Alcohol Sulphates,” Tenside Detergents, Vol. 17, 1980, both of which are incorporated herein by reference. Accordingly, it is unnecessary to present detailed procedures for each such reaction.

To more fully demonstrate the invention, the following non-limiting examples are presented.

### EXAMPLE 1

The sodium salt of a sulfated, propoxylated alcohol, having the general structure shown in Formula I, was prepared by reacting the monobranched alcohol, marketed as ISALCHEM, with propylene oxide using an aqueous sodium hydroxide catalyst. ISALCHEM 125 has the general structure shown in Formula II. The reaction was conducted at 125° C. under standard propoxylation conditions in a 350 ml laboratory alkoxylation reactor. The reaction product was neutralized with glacial acetic acid. This alcohol propoxylate was next sulfated using an SO₃/air mixture in a standard batch sulfator under standard sulfation reaction conditions. Specifically, sulfation was carried out at a temperature of 40° C. The sulfated product was then neutralized with sodium hydroxide.

The reaction mixture was found to contain 35% active alcohol propoxy sulfate, which contained 8 mols of propylene oxide—i.e., x is 8.

### EXAMPLE 2

The procedure of Example 1 was basically followed with the exception that the starting material alcohol employed, ISALCHEM 145, was that depicted in Formula IV. The alcohol propoxylate produced contained 4 mols of propylene oxide; i.e., x is 4. The reaction produced contained 30% by weight active ether sulfate.

The compositions ofthe present invention are highly effective in soil remediation wherein the soil is contaminated to a considerable depth with a water-insoluble, organic pollutant, using a technique similar to waterflooding that is used in the recovery of oil from depleting formations. The surfactants of the present invention are effective for the removal from soil of a wide variety of organics including diesel, other fuel oils, chlorinated organics, etc.

It is believed that the surfactants of the present invention when used in soil remediation processes possess particular advantages. For one, the surfactants are similar to anionic surfactants, commonly referred to as alcohol ether sulfates, found in common household laundry and dishwashing detergents. However, the surfactants differ from such typical anionic surfactants in that the alcohol moiety has a single branch point with branches consisting of methyl, ethyl, propyl, butyl, and pentyl groups. This branching is believed to give excellent oil solubility, which would not be achieved with linear alcohols. The surfactants also differ from the typical anionic surfactants in that the hydrophilic portion ofthe surfactants is a propoxylated sulfate rather than an ethoxylated sulfate and propoxylation is known to promote oil solubility.

It is also believed that the surfactants ofthe present invention, in soil remediation work, will show desirable biodegradability properties, which, given the structure of the molecule, can generally be predicted as follows:

Initially biodegradation will be the hydrolytic removal of the sulfate or other hydrophilic group to produce the alcohol propoxylate. Next, the propoxylate groups will be attacked by a combination of either scission (to produce the alcohol plus propylene glycol or sequential propylene glycol monomers) and oxidation of the terminal —OH group of the propylene glycol to the carboxylate group. The attack on the propylene glycol units is expected to be slower than with ethoxylated surfactants but should nonetheless proceed to completion. The alcohol moiety will also be attacked by further oxidation of the —OH, followed by beta oxidation. The branch point of the number two carbon in the molecule should result in slower oxidation than with linear alcohols but should also proceed to completion. Thus, this branched alcohol is clearly preferable (from a biodegradation viewpoint) as compared to the widely commercialized iso-alcohols that have methyl branching on every third or fourth carbon atom. It is believed that the type of branching unique to the surfactants of the present invention effectively puts “speed bumps” on the biodegradability of the alcohols; i.e., it slows the rate of biodegradation in biologically active subsurface environments to ensure that the surfactant has a sufficiently long lifetime to be effective at removing the soil contaminant.

Although total aquatic toxicity of the surfactant has not been established, the screening toxicity bioassay (MICROTOX™) has shown that the surfactant is relatively nontoxic to the test microorganisms. EC₅₀ could not be registered at 900 mg/liter, the highest test concentration. Typically, surfactants of this general type have EC₅₀ values in the 1 to 100 mg/liter range. Based on the structure of the molecule, it is predicted that the surfactants of the present invention will be less eco-toxic than those typically used in everyday household laundry and dishwashing detergents.

The foregoing description and examples illustrate selected embodiments of the present invention. In light thereof, variations and modifications will be suggested to one skilled in the art, all of which are in the spirit and purview of this invention.

What is claimed is:

1. A surfactant composition, comprising compounds having the structure: 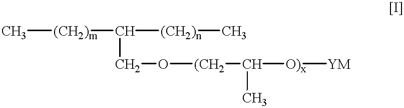
wherein m+n is from 8 to 11, x is from 2 to 10, Y is a hydrophilic group, and M is a cation.

2. The composition of claim 1 wherein m+n is from 8 to 9.

3. The composition of claim 1 wherein m+n is from 8 to 11.

4. The composition of claim 1 where m+n is from 10 to 11.

5. The composition of claim 1 wherein M is a monovalent cation.

6. The composition of claim 1 wherein M is selected from the group consisting of an alkali metal, NH₄—, monoalkanolammonium, dialkanolammonium, trialkanolammonium, magnesium, and mixtures thereof.

7. The composition of claim 1 wherein Y is selected from the group consisting of sulfate, sulfonic, phosphate, carboxylate, and mixtures thereof.

8. The composition of claim 1 wherein x is from 4 to 8.
